(19) United States
(12) Patent Application Publication
(10) Pub. No.: US 2011/0012867 A1
(43) Pub. Date: Jan. 20, 2011

(54) OPTICAL TOUCH SCREEN DEVICE

(75) Inventor: Chun-Yu Lee, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/698,217

(22) Filed: Feb. 2, 2010

(30) Foreign Application Priority Data
Jul. 20, 2009 (CN) 200910304523.4

(51) Int. Cl. G06F 3/042

(52) U.S. Cl. 345/175

(57) ABSTRACT

An optical touch screen device includes a display screen, a number of infrared sensors, two infrared sources, and a processing unit. The display screen has N sides, wherein N represents an integer greater than two. The number of infrared sensors is N−1. The N−1 infrared sensors are arranged adjacent N−1 sides of the display screen, respectively. The two infrared light sources are arranged at the remaining side such that light emitted from each of the two infrared sources cover the entire display screen and reaches the infrared sensors. The N−1 infrared sensors are configured for detecting locations of the shadows of an input device formed thereon and generating signals associated with the locations of the shadows. The processing unit is electrically connected to the infrared sensors for processing the signals to calculate a location of an input device on the surface of the display screen.

### BACKGROUND

1. Technical Field

The present disclosure relates to an optical touch screen device.

2. Description of Related Art

A touch panel incorporated into a thin film transistor (TFT) liquid crystal display (LCD) has been proposed. A typical LCD includes a pair of glass plates which are separated by a layer of liquid crystal material. Commonly, the touch panel can be selected from a resistive touch panel and a capacitive touch panel.

In the above-described LCD, the touch panel is usually attached to a display screen of the LCD. However, such arrangement inevitably increases the thickness of the LCD. Furthermore, luminance of the LCD may suffer.

Therefore, an optical touch screen device which can overcome the above-mentioned problems is desired.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic, top view of an optical touch screen device in accordance with a first exemplary embodiment.

FIG. 2 is a schematic, top view of the optical touch screen device of FIG. 1 with an input device located at a first location on the display screen of the optical touch screen device.

FIG. 3 is a schematic, top view of the optical touch screen device of FIG. 1 with the input device located at a second location on the display screen of the optical touch screen device.

FIG. 4 is a schematic, top view of an optical touch screen device in accordance with a second exemplary embodiment.

FIG. 5 is a schematic, top view of an optical touch screen device in accordance with a third exemplary embodiment.

### DETAILED DESCRIPTION

Various embodiments will now be described in detail below with reference to the drawings.

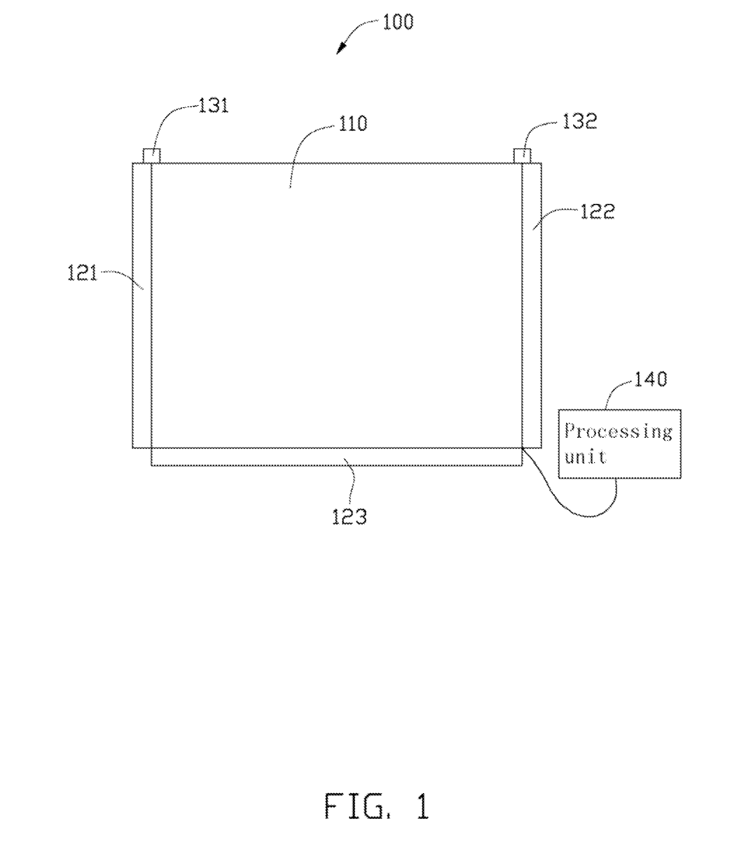

Referring to FIG. 1, an optical touch screen device 100 in accordance with a first exemplary embodiment includes a display screen 110, a first infrared (IR) sensor 121, a second IR sensor 122, a third IR sensor 123, a first IR source 131, a second IR source 132, and a processing unit 140.

In this embodiment, the display screen 110 is rectangular. The display screen 110 can be selected from the group consisting of a liquid crystal display screen, a field emission display screen and a plasma display screen.

The first, second and third IR sensors 121, 122, 123 are linear IR sensors for detecting IR light, but can be linear charge coupled devices, or linear complementary metal oxide semiconductors. The first, second, and third IR sensors 121, 122, and 123 are adjacent three sides of the display screen 110, respectively. The first, second, and third IR sensors 121, 122, 123 each have a length substantially equal to the length of the corresponding side of the display screen 110. The first IR sensor 121 is parallel with the second IR sensor 122, and the third IR sensor 123 is perpendicular to the first and second IR sensors 121, 122. One end of the third IR sensor 123 abuts against one end of the first IR sensor 121 while the other end of the third IR sensor 123 abuts against one end of the second IR sensor 122. The processing unit 140 is electrically connected to, and receives/processes signals from the first, second, and third IR sensors 121, 122, 123.

The first and second IR sources 131 and 132 are arranged at the remaining side of the display screen 110. In this illustrated embodiment, the first and second IR sources 131, 132 are point light sources positioned at two opposite ends of the remaining side of the display screen 110. The first and second IR sources 131, 132 can be IR light emitting diodes or IR laser diodes. Light emitted from each of the first and second IR sources 131, 132 form a light field. The light fields of the first and second IR sources 131, 132 each cover the entire surface of display screen 110 and reach the three IR sensors 121, 122, 123.

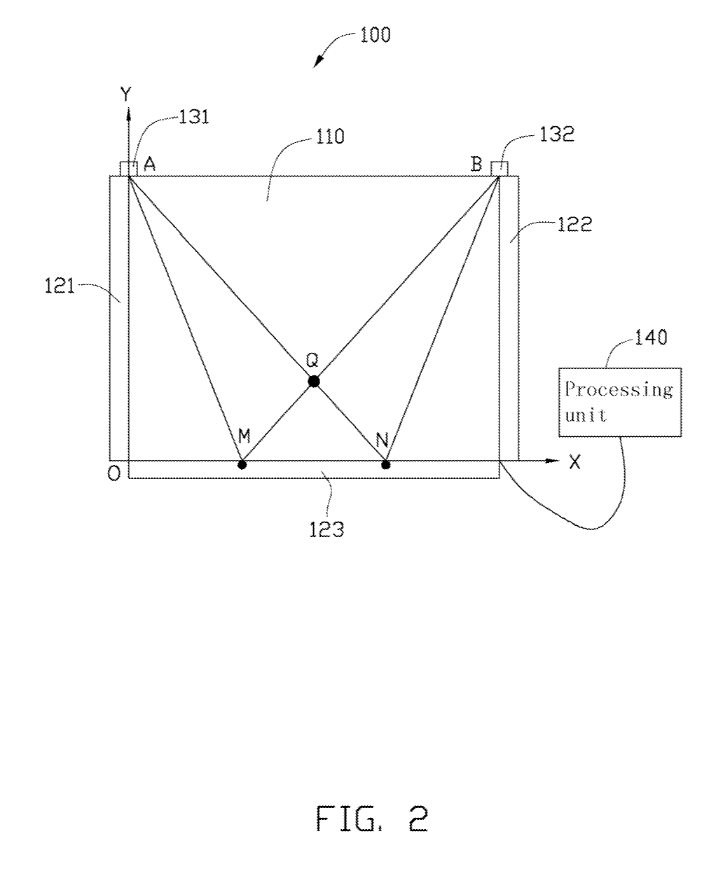

Referring to FIG. 2, the location of the first IR light source 131 is A, and that of the second IR light source 132 is B. An input device, such as a stylus, is located at a location Q on the display screen 110. In this case, part of the light emitted from the first IR light source 131 is intercepted by the input device, thus an intensity of IR of a location N on the third IR sensor 123 is reduced. In other words, a shadow is formed on the location N of the IR sensor 123. The location N is in alignment with the location Q and the first IR light source 131. Similarly, the input device intercepts part of the light emitted from the second IR light source 132, thus the intensity of IR of the location M on the third IR sensor 123 is reduced. In other words, a shadow is formed on the location M of the IR sensor 123. The location M is in alignment with the location Q and the second IR light source 132. The third IR sensor 123 detects the locations M and N and generates a signal accordingly which in turn is sent to the processing unit 140. The processing unit 140 processes the signal and calculates a coordinate of the location Q on the display screen 110. That is, the location of the input device at the location Q is detected.

An X-Y coordinate system is defined by two sides of the display screen 110, wherein an X axis of the coordinate system is located along the side adjacent to the third IR sensor 123, and the Y axis of the coordinate system is located along the side adjacent to the first IR sensor 121. An origin O of the coordinate system is defined by the X axis intersecting the Y axis. The location Q can be obtained by a line AN intersecting a line BM, wherein the line AN connects the location A to the location N and the line BM connects the location B to the location M. Therefore, the location Q can be obtained according to the locations M and N. The processing unit 140 processes the signal and calculates a coordinate of the location Q in the X-Y coordinate system. That is, a location of the input device on the display screen 110 is detected.

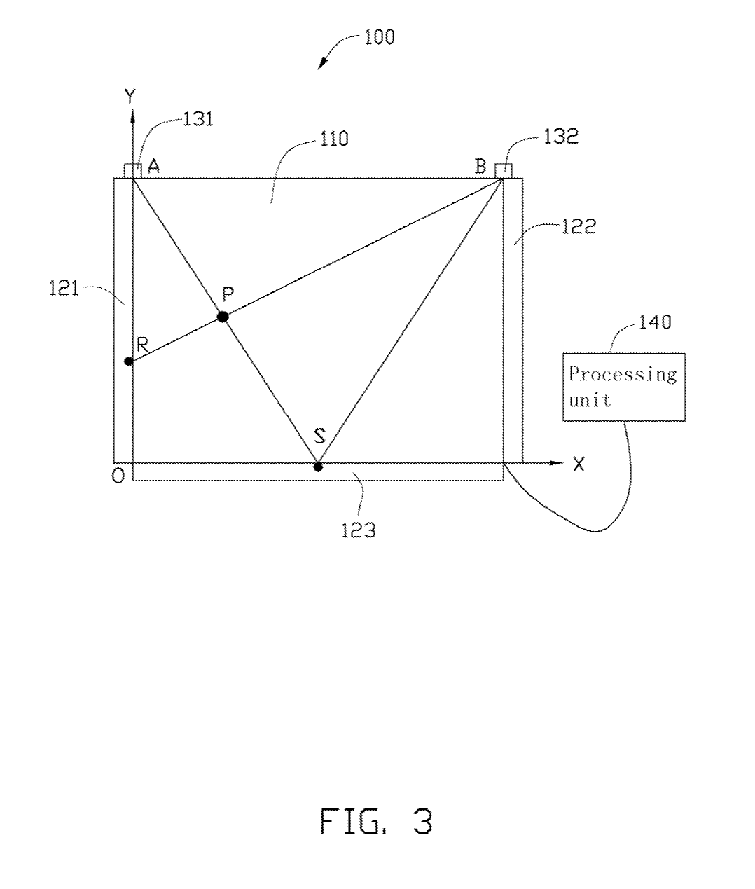

Referring to FIG. 3, when the input device is located at a location P on the display screen 110. Part of the light emitted from the second IR light source 132 is intercepted by the input device, thus an intensity of IR of a location R on the first IR sensor 121 is reduced. Similarly, the input device intercepts part of the light emitted from the first IR light source 131, thus the intensity of IR of a location S on the third IR sensor 123 is reduced. In other words, a shadow is formed on the location R of the IR sensor 121, and a shadow is formed on the location S of the IR sensor 123. A coordinate of the location P can be obtained according to the locations R and S using a method similar to the above. That is, a location of the input device on the display screen 110 is detected. Therefore, a coordinate of the input device located at any locations on the display screen 110 can be detected by two locations with low IR intensity because of IR light being intercepted by the input device.

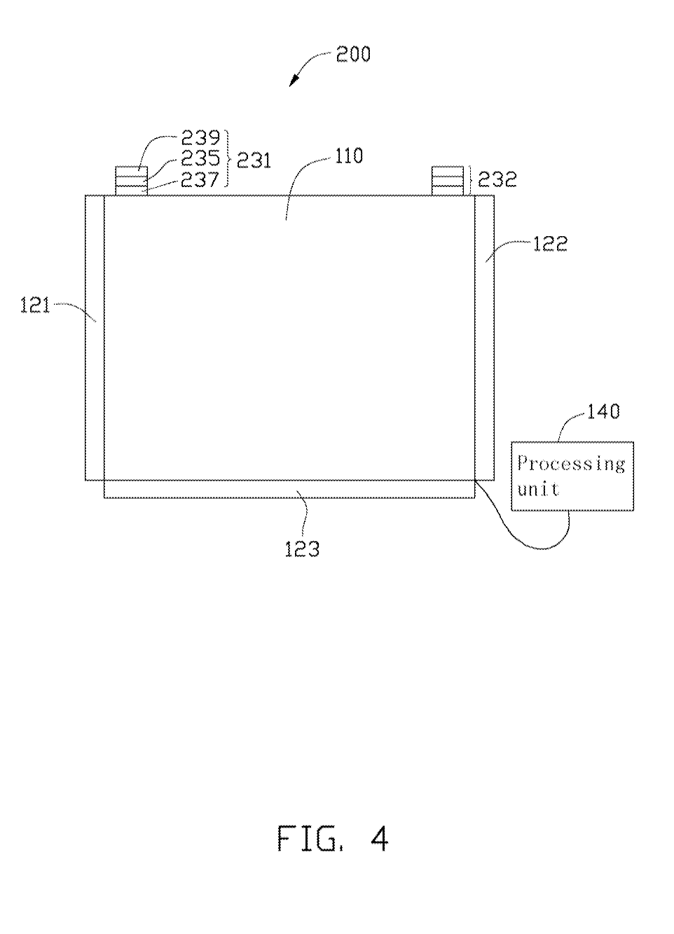

Referring to FIG. 4, an optical touch screen device 200 in accordance with a second exemplary embodiment is provided. The optical touch screen device 200 differs from the optical touch screen device 100 in that the optical touch screen device 200 includes a first IR light source 231 instead of the first IR light source 131, and a second IR light source 232 instead of the second IR light source 132. The first IR light source 231 is identical to the second IR light source 232. Therefore, just the first IR light source 231 is described in detail as follows. The first IR light source 231 includes a first IR light emitting diode 235, a first collimating lens 237 arranged in front of the first IR light emitting diode 235, and a first rotating member 239 connecting to the first IR light emitting diode 235. The first collimating lens 237 is configured for collimating light emitted from the first IR light emitting diode 235. The first rotating member 239 is configured for driving the first emitting diode 235 and the first collimating lens 237 to rotate about an axis perpendicular to the display screen 110 such that the light emitted from the first IR light emitting diode 235 can cover the entire surface of display screen 110 and reach the three IR sensors 121, 122, 123.

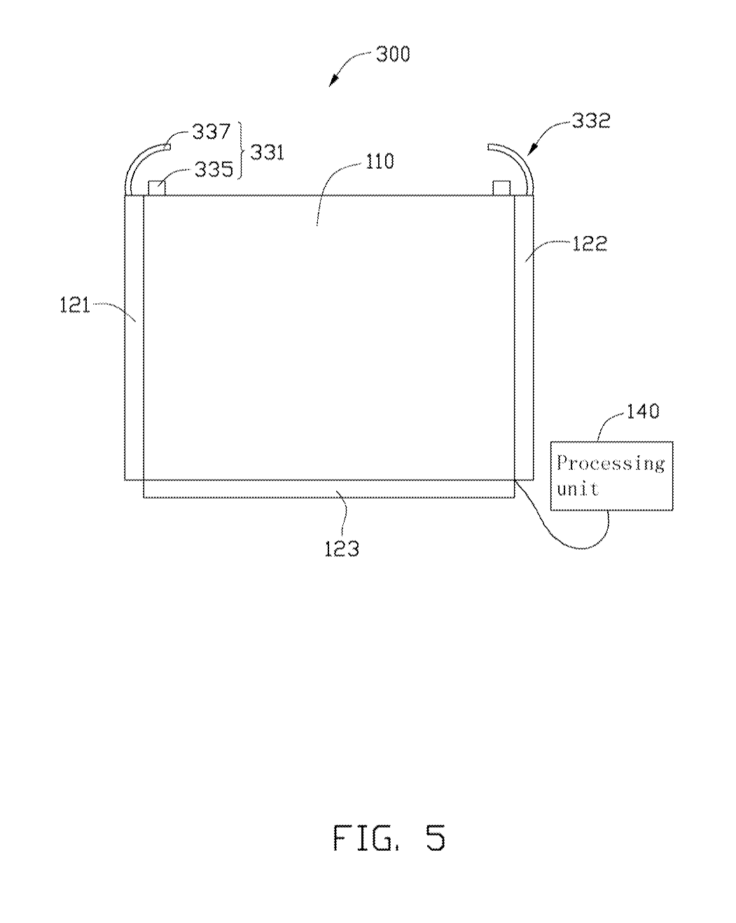

Referring to FIG. 5, an optical touch screen device 300 in accordance with a third exemplary embodiment is provided. The optical touch screen device 300 differs from the optical touch screen device 100 in that the optical touch screen device 300 includes a first IR light source 331 instead of the first IR light source 131, and a second IR light source 332 instead of the second IR light source 132. The first IR light source 331 is identical to the second IR light source 332. Therefore, just the first IR light source 331 is described in detail as follows. The first IR light source 331 includes a first IR light emitting diode 335 and a reflective cover 337. The reflective cover 337 is arranged adjacent to the first IR light emitting diode 335 and facing the display screen 110. The reflective cover 337 is configured for reflecting the light emitted from the first IR light emitting diode 335 such that the light emitted from the first IR light emitting diode 335 covers the entire surface of the display screen and reaches the three IR sensors 121, 122, 123.

It is to be understood that a shape of the display screen 110 can also be other polygons, such as a trapezium, a triangle, or a polygon having more than four sides. The number of the IR sensors 121, 122, 123 changes along with the number of side of the polygon. Assuming that the number of side of the polygon is represented by N, the number of IR sensor equals to N−1, wherein the character N represents an integer greater than two. The IR sensors are arranged along sides of the polygon, and two IR light sources arranged at the remaining side of the polygon. Light emitted from each of the IR light sources covers the entire surface of the display screen and reaches the three IR sensors.

In the optical touch screen devices 100, 200, and 300 of this disclosure, there is no additional layer arranged on the display screen 110. Therefore, the optical touch screen devices 100, 200, and 300 are thin and bright.

Finally, it is to be understood that the above-described embodiments are intended to illustrate rather than limit the disclosure. Variations may be made to the embodiments without departing from the spirit of the disclosure. The above-described embodiments illustrate the scope of the disclosure but do not restrict the scope of the disclosure.

1. An optical touch screen device comprising:
a display screen having N sides, N being an integer greater than two;
N−1 infrared sensors arranged along N−1 sides of the display screen, respectively;
a first and second infrared light sources being arranged at the remaining side of the display screen such that light emitted from each of the first and second infrared light sources covers the entire surface of the display screen and reaches the N−1 infrared sensors, the N−1 infrared sensors configured for detecting locations of the shadows of an input device formed thereon by the light emitted from the first and second infrared light sources and generating signals associated with the locations of the shadows; and
a processing unit electrically connected to the N−1 infrared sensors for processing the signals to calculate a position of the input device on the surface of the display screen.

2. The optical touch screen device of claim 1, wherein each of the N−1 infrared sensors is a linear infrared sensor parallel with the respective side of the display screen.

3. The optical touch screen device of claim 1, wherein the display screen is rectangular, the number of infrared sensor being three, the three infrared sensors being respectively arranged adjacent three sides of the display screen, the three infrared sensors abutting against one another, the first and second infrared light sources being arranged adjacent the remaining side of the display screen.

4. The optical touch screen device of claim 1, wherein the first and second infrared light sources are arranged at two opposite ends of the remaining side, respectively.

5. The optical touch screen device of claim 1, wherein each of the first and second infrared light sources comprises an infrared light emitting diode, a collimating lens arranged in front of the infrared light emitting diode, and a rotating member connected to the infrared light emitting diode, the collimating lens configured for collimating light emitted from the infrared light source, the rotating member configured for rotating the infrared light emitting diode and the collimating member about an axis perpendicular to the surface of the display screen such that the light emitted from the infrared light emitting diode covers the entire surface of display screen and reaches the N−1 infrared sensors.

6. The optical touch screen device of claim 1, wherein each of the first and second infrared light sources comprises an infrared light emitting diode and a reflective cover, the reflective cover arranged adjacent to the infrared light emitting diode and facing the display screen, the reflective cover configured for reflecting light emitted from the infrared light emitting diode such that the light emitted from the first infrared light emitting diode covers the entire surface of the display screen and reaches the N−1 infrared sensors.
